(19) United States
(12) Patent Application Publication
(10) Pub. No.: US 2012/0169575 A1
(43) Pub. Date: Jul. 5, 2012

(54) LIQUID CRYSTAL DISPLAY PANEL FOR SOLVING COLOR SHIFT

(76) Inventor: Chin-Hai Huang, Taoyuan County (TW)

(21) Appl. No.: 13/053,207

(22) Filed: Mar. 22, 2011

(30) Foreign Application Priority Data
Jan. 5, 2011 (TW) 100100283

(51) Int. Cl. G09G 3/36

(52) U.S. Cl. 345/88

(57) ABSTRACT

A liquid crystal display panel for solving color shift includes a first pixel, a second pixel and a third pixel. The first pixel includes a first pixel electrode and a first storage electrode having a first common voltage. The first pixel electrode and the first storage electrode form a first storage capacitor. The second pixel includes a second pixel electrode and a second storage electrode having a second common voltage. The second pixel electrode and the second storage electrode form a second storage capacitor. The third pixel includes a third pixel electrode and a third storage electrode having a third common voltage. The third pixel electrode and the third storage electrode form a third storage capacitor. The first common voltage is not equal to at least one of the second common voltage and the third common voltage.

### BACKGROUND OF THE INVENTION

1. Field of the Invention

The present invention is related to a liquid crystal display (LCD) panel, and more particularly, to a wide-view LCD panel that is able to solve the color shift problem.

2. Description of the Prior Art

The LCD panel utilizes uniform lights from an accompanied backlight module, and thus provides images. When the incident light passes through the LCD panel and emits from the LCD panel, the emitted light obtains a specific direction, typically a direction perpendicular to the panel. Accordingly, when a user looks at the display from different viewing angels, the user perceives an abnormal image or image with inferior illuminance. As countermeasures against to the problem, there have been developed different wide viewing angle technologies such as in-plane switching (IPS) or vertical alignment (VA). The viewing angle with IPS or VA technology can achieve 170 degree angle. Among those approaches, VA technology have high market share (up to 40%).

However, VA technology always faces a serious color shift problem: When the user looks at the LCD from large viewing angle, the user perceives color tones different from red, green and blue, and color washout problem. For example, the user perceives a skin color shifting to blue or white. Please refer to FIGS. 1A and 1B, which are gamma curve graphs illustrating the transmittance-voltage characteristic of a VA mode LCD panel respectively corresponding to a front viewing angle and a large viewing angle. The abscissas of FIGS. 1A-1B represent the gray scales and the ordinates of FIGS. 1A-1B represent the transmittance. As shown in FIG. 1A, at the front viewing angle, the red gamma curve 10R, the green gamma curve 10G and the blue gamma curve 10B substantially overlap to each other. Nevertheless, the red gamma curve 12R, the green gamma curve 12G and the blue gamma curve 12B all shift at the large viewing angle while the blue gamma curve 12B suffers the most serious shifting problem as shown in FIG. 1B. In other words, when applying VA technology, transmittances at front viewing angle and large viewing angles are different even at the same gray-scale voltage. Such phenomenon is so-called color shift.

In order to solve the abovementioned color shift problem, the prior art has developed different methods, such as to divide a pixel region into two sub-regions according to different gamma curves. Thus the color shift problem is mitigated by mixing color. However, such approach lowers the aperture ratio and complicates the system circuit and the process because it has to design and add another circuit for adjusting the gamma curve.

### SUMMARY OF THE INVENTION

Therefore the present invention provides an LCD panel that is able to solve the color shift problem without complicating the system circuit and the manufacturing processes in the state-of-the-art.

According to an aspect of the present invention, an LCD panel is provided. The LCD panel includes a first substrate having a first pixel region, a second pixel region, and a third pixel region. The LCD panel further includes a first pixel formed in the first pixel region, a second pixel formed in the second pixel region, and a third pixel region formed in the third pixel. The first pixel includes a first pixel electrode and a first storage electrode positioned on the first substrate. The first storage electrode has a first common voltage, and the first pixel electrode and the first storage electrode form a first storage capacitor. The second pixel includes a second pixel electrode and a second storage electrode positioned on the first substrate. The second storage electrode has a second common voltage, and the second pixel electrode and the second storage electrode form a second storage capacitor. The third pixel includes a third pixel electrode and a third storage electrode positioned on the first substrate. The third storage electrode has a third common voltage, and the third pixel electrode and the third storage electrode form a third storage capacitor. Furthermore, the first common voltage is not equal to at least one of the second common voltage and the third common voltage.

According to the LCD panel provided by the present invention, the first common voltage, the second common voltage and the third common voltage are respectively provided to the first storage electrode, the second storage electrode and the third storage electrode, and first common voltage is not equal to at least one of the second common voltage and the third common voltage. Accordingly, even the first pixel, the second pixel and the third pixel obtain the same gray-scale voltages from the data lines, the gray scale of the first pixel is different from that of the second pixel and of the third pixel because the difference between the first common voltage and at least one of the second common voltage and the third common voltage. Consequently, the color shift problem is solved even at large viewing angle.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1A and 1B are gamma curve graphs illustrating the transmittance-voltage characteristic of a VA mode LCD panel respectively corresponding to a front viewing angle and a large viewing angle.

FIG. 2 is an equivalent circuit diagram of an LCD panel provided by a first preferred embodiment of the present invention.

FIG. 3 is a drawing illustrating pixel arrangement of the LCD panel provided by the first preferred embodiment.

FIG. 4 is a drawing illustrating a color filter substrate of the LCD panel provided by the first preferred embodiment.

FIG. 5 is an equivalent circuit diagram of an LCD panel provided by a second preferred embodiment of the present invention.

FIG. 6 is a drawing illustrating pixel arrangement of the LCD panel provided by the second preferred embodiment.

FIG. 7 is a drawing illustrating a color filter substrate of the LCD panel provided by the second preferred embodiment.

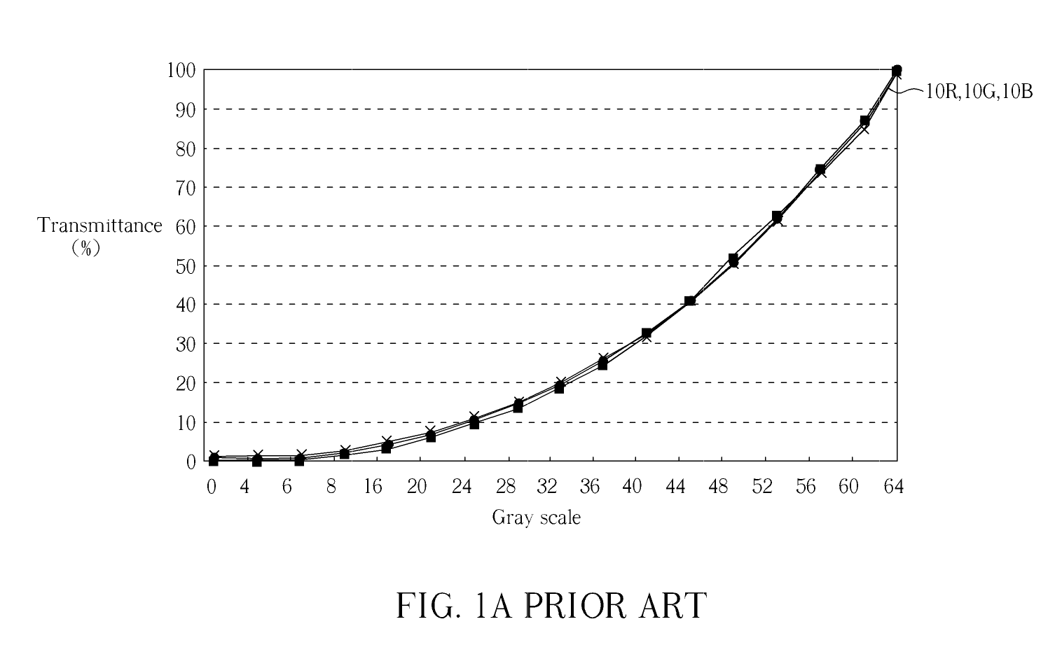

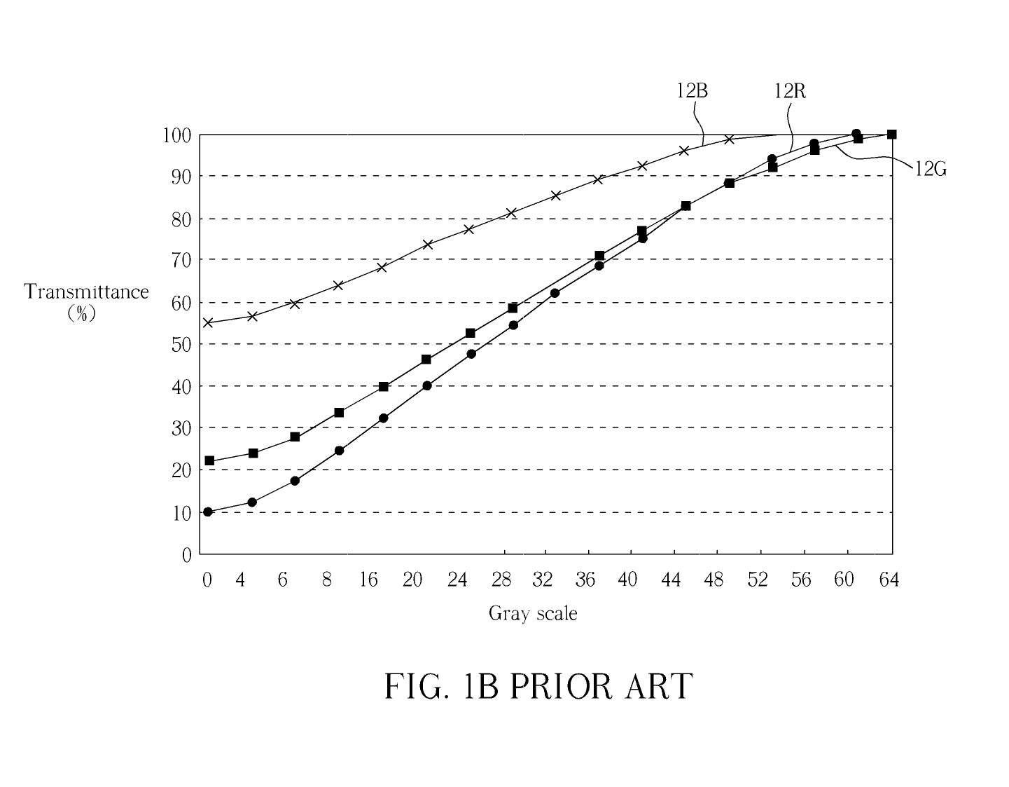

### DETAILED DESCRIPTION

Certain terms are used throughout the description and following claims to refer to particular components. As one skilled in the art will appreciate, electronic equipment manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”.

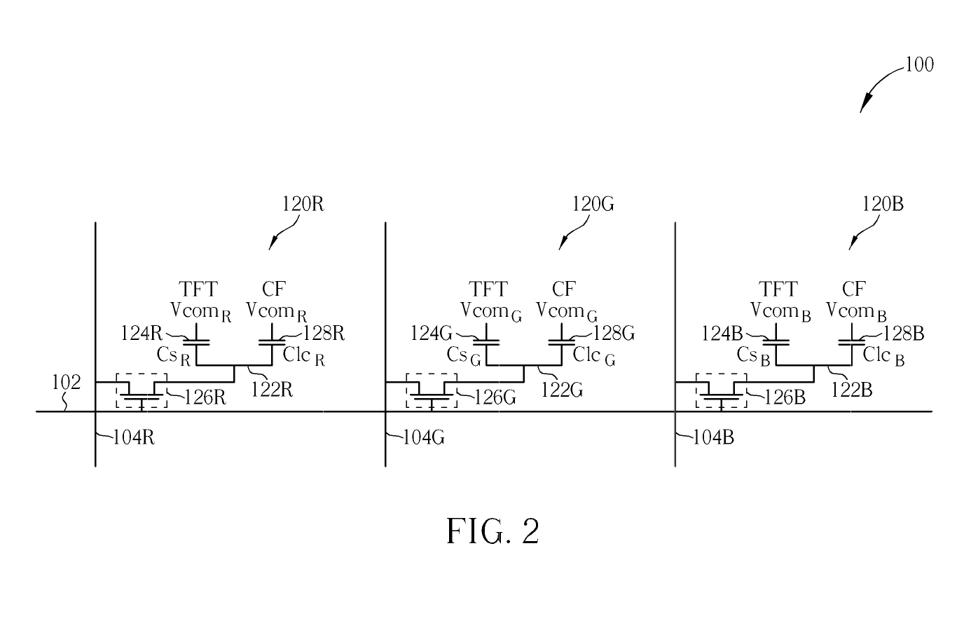

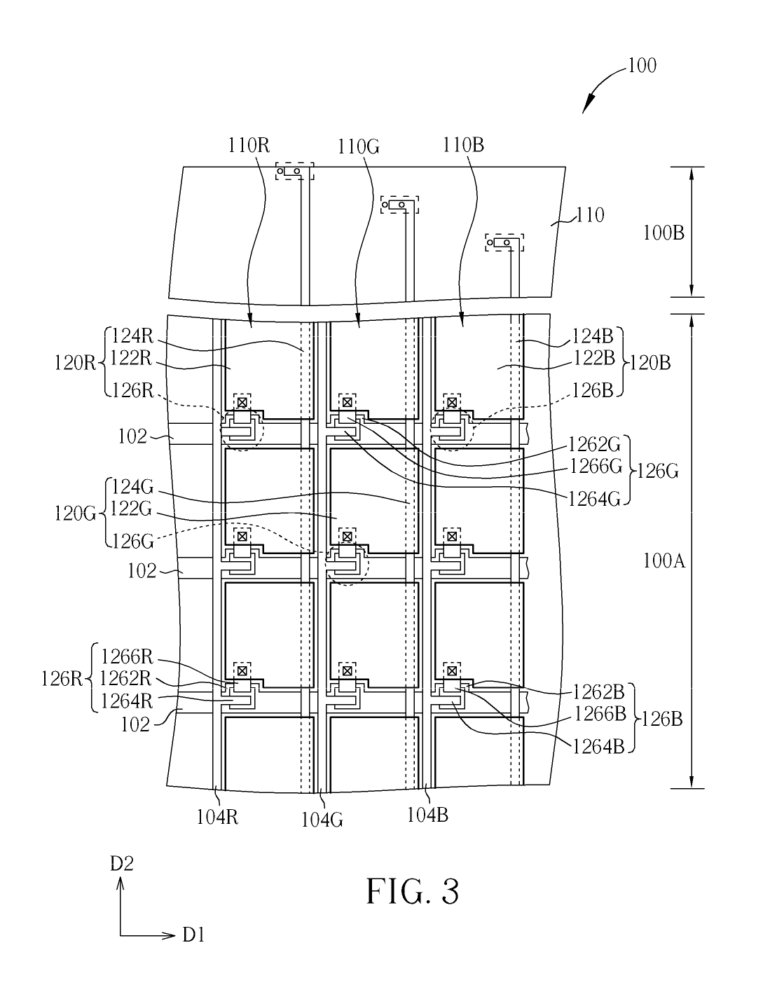

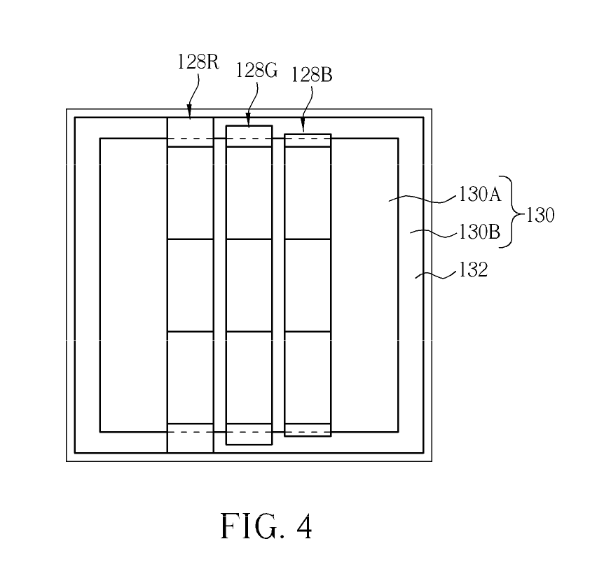

Please refer to FIGS. 2-4, wherein FIG. 2 is an equivalent circuit diagram of an LCD panel provided by a first preferred embodiment of the present invention, FIG. 3 is a drawing illustrating pixel arrangement of the LCD panel provided by the first preferred embodiment, and FIG. 4 is a drawing illustrating a color filter substrate of the LCD panel provided by the first preferred embodiment. As shown in FIG. 2 and FIG. 3, the first preferred embodiment provides an LCD panel 100 including a first substrate 110 (shown in FIG. 3), such as a thin film transistor (TFT) array substrate. The first substrate 110 includes a display region 100A and a peripheral circuit region 100B defined thereon. The LCD panel 100 includes at least a scan line 102 positioned along a first direction D1 on the first substrate 110. The LCD panel 100 further includes a first data line 1048, a second data line 104G and a third data line 104R all positioned along a second direction D2 on the first substrate 110. The first direction D1 is perpendicular to the second direction D2. As shown in FIG. 2 and FIG. 3, the scan line 102 and the first data line 104B define a first pixel region 110B, the scan line 102 and the second data line 104G define a second pixel region 110G, and the scan line 102 and the third data line 104R define a third pixel region 110R.

The LCD panel 100 further includes a first pixel 120B formed in the first pixel region 110B, a second pixel 120G formed in the second pixel region 110G, and a third pixel 120R formed in the third pixel region 110R. In the preferred embodiment, the first pixel 120B is a blue pixel, the second pixel 120G is a green pixel, and the third pixel 120R is a red pixel. As shown in FIG. 3, the first pixel 120B includes a first pixel electrode 122B, a first storage electrode 1248, and a first TFT 126B positioned on the first substrate 110. The second pixel 120G includes a second pixel electrode 122G, a second storage electrode 124G and a second TFT 126G positioned on the first substrate 110. And the third pixel 120R includes a third pixel electrode 122R, a third storage electrode 124R and a third TFT 126R positioned on the first substrate 110. As shown in FIG. 3, the first pixels 120B are arranged along the second direction D2 and positioned on a side of the first data line 104B. That means the first pixels 120 are arranged parallel with the first data line 104B. In the same concept, the second pixels 120G are arranged parallel with the second data line 104G, and the third pixels 120R are arranged parallel with the third data line 104R. It is well-known to those skilled in the art that the scan line 102, the first data line 104B, the second data line 104G, and the third data line 104R all extend from the display region 100A of the first substrate 110 into the peripheral circuit region 100B and the scan line 102 is electrically connected to a scan line driving circuit while the first data line 104B, the second data line 104G, and the third data line 104R are electrically connected to a data line driving circuit in the peripheral circuit region 100B. Since the details are well-known to those skilled in the art, those details are omitted hereinafter and FIGS. 2-4.

As shown in FIG. 2, the first storage electrode 124B has a first common voltage Vcom_{B}, the second storage electrode 124G has a second common voltage Vcom_{G}, and the third storage electrode 124R has a third common voltage Vcom_{R}. It is noteworthy in the preferred embodiment, the first common voltage Vcom_{B} is not equal to the second common voltage Vcom_{G}, the second common voltage Vcom_{G} is not equal to the third common voltage Vcom_{R}, and the third common voltage Vcom_{R} is not equal to the first common voltage Vcom_{B}, either. It other words, the first common voltage Vcom_{B}, the second common voltage Vcom_{G}, and the third common voltage Vcom_{R} are different from each other. Furthermore, the first pixel electrode 122B and the first storage electrode 124B form a first storage capacitor Cs_{B}, the second pixel electrode 122G and the second storage electrode 124G form a second storage capacitor Cs_{G}, and the third pixel electrode 122R and the third storage electrode 124R form a third storage capacitor Cs_{R}. As shown in FIG. 3, the first storage electrode 124B is arranged along the second direction D2 that means the first storage electrode 124B is formed parallel with the first data line 104B. In the same concept, the second storage electrode 124G is formed parallel with the second data line 104G, and the third storage electrode 124R is formed parallel with the third data line 104R. It is noticeable that the first storage electrode 124B, the second storage electrode 124G and the third storage electrode 124R extend from the display region 100A of the first substrate 110 into the peripheral circuit region 100B of the first substrate 110, and lengths of the first storage electrode 124B, the second storage electrode 124G and the third storage electrode 124R are different from each other. Therefore, terminals of the first storage electrode 1248, the second storage electrode 124G, and the third storage electrode 124R are positioned at different points along the second direction D2 in the peripheral circuit region 100B as shown in FIG. 3.

Please still refer to FIG. 3. The first TFT 126B further includes a first gate 1262B electrically connected to the scan line 102, a first source 1264B electrically connected to the first data line 104B, and a first drain 1266B electrically connected to the first pixel electrode 122B. The second TFT 126G further includes a second gate 1262G electrically connected to the scan line 102, a second source 1264G electrically connected to the second data line 104G, and a second drain 1266G electrically connected to the second pixel electrode 122G. The third TFT 126R further includes a third gate 1262R electrically connected to the scan line 102, a third source 1264R electrically connected to the third data line 104R, and a third drain 1266R electrically connected to the third pixel electrode 122R. Those skilled in the art would easily realize that the first gate 1262B controls the first TFT 1268 to be turned on or off according to the control signals from the scan line 102, and fist pixel electrode 1228 receives gray scale voltages from the first drain 1266B, the first source 1264B and the first data line 1048, and thus controls the rotations of the LC molecules in the first pixel region 110B according to voltage difference between the gray-scale voltage and the first common voltage Vcom_{B}. In the same concept, the second TFT 126G and the third TFT 126R is turned on or off according to the control signals from the scan line 102, and the rotations of the LC molecules in the second pixel region 110G and the third pixel region 110R is also are respectively controlled by the second TFT 126G and the third TFT 126R as mentioned above. Therefore, the details are omitted for the sake of simplicity.

Please refer to FIG. 4 and both of FIG. 2 and FIG. 3. According to the preferred embodiment, the LCD panel 100 further includes a second substrate 130 such as a color filter substrate. The second substrate 130 also includes a display region 130A and a peripheral circuit region 130B. The first pixel 120B further includes a first common electrode 128B, the second pixel 120G further includes a second common electrode 128G, and the third pixel 120R further includes a third common electrode 128R. All of the common electrodes 128B/128G/128R include transparent conductive materials and are formed on the second substrate 130. The first common electrode 128B is electrically connected to the first storage electrode 124B, and the first common electrode 1288 and the first pixel electrode 1228 form a first liquid crystal capacitor Clc_{B}. In the same concept, the second common electrode 128G is electrically connected to the second storage electrode 124G, and the second common electrode 128G and the second pixel electrode 122G form a second liquid crystal capacitor Clc_{G}. The third common electrode 128R is electrically connected to the third storage electrode 124R, and the third common electrode 128R and the third pixel electrode 122R form a third liquid crystal capacitor Clc_{R}.

It is noteworthy that the first common electrode 128B is formed corresponding to the first pixel region 110B, the second common electrode 128G is formed corresponding to the second pixel region 110G, and the third common electrode 128R is formed corresponding to the third pixel region 110R. Therefore the first common electrode 1288, the second common electrode 128G, and the third common electrode 128R are parallel with each other as shown FIG. 4. The first common electrode 128B, the second common electrode 128G, and the third common electrode 128R are arranged individually and respectively according to blue, green red without contacting. Furthermore, the first common electrode 128B, the second common electrode 128G, and the third common electrode 128R extend from the display region 130A into the peripheral circuit region 1308. More important, lengths of the first common electrode 1288, the second common electrode 128G and the third common electrode 128R are respectively corresponding to the lengths of the first storage electrode 1248, the second storage electrode 124G, and the third storage electrode 124R. And terminals of the first common electrode 128B, the second common electrode 128G and the third common electrode 128R are positioned in different points in the peripheral circuit region 130B as shown in FIG. 4. For example, the first common electrode 128B is corresponding to the first storage electrode 124B and has the shortest length, and the two terminals of the first storage electrode 124B are corresponding to the two terminals of first storage electrode 124B. The third common electrode 128R is corresponding to the third storage electrode 124R and has the longest length, and the two terminals of the third common electrode 128R are corresponding to the two terminals of the third storage electrode 124R. The length of the second common electrode 128G is corresponding to the second storage electrode 124G and is between the lengths of the first common electrode 128B and of the third common electrode 128R, and the two terminals of the second common electrode 128G are corresponding to the two terminals of the second storage electrode 124G. By conductive material 132 such as conductive spacer in the sealant or Ag-sealant, the first common electrode 128B, the second common electrode 128G, and the third common electrode 128R are respectively electrically connected to the first storage electrode 124B, the second storage electrode 124G, and the third storage electrode 124R in the peripheral circuit region 130B.

Please refer to FIG. 2 again. According to the preferred embodiment, the first common electrode 128B electrically connected to the first storage electrode 124B has the first common voltage Vcom_{B}, the second common electrode 128G electrically connected to the second storage electrode 124G has the second common voltage Vcom_{G}, and the third common electrode 128R electrically connected to the third storage electrode 124R has the third common voltage Vcom_{R}. As mentioned above, the first common voltage Vcom_{B}, the second common voltage Vcom_{G}, and the third common voltage Vcom_{R} are different from each other.

According to the first preferred embodiment, when the first TFT 1268, the second TFT 126G and the third 126B are turned on according to the control signal from the same scan line 102, and the gray-scale voltages are respectively received from the first data line 104B, the second data line 104G and the third data line 104R, the first common voltage Vcom_{B}, the second common voltage Vcom_{G} and the third common voltage Vcom_{R} that are different from each other are provided. By voltage difference between the different common voltage Vcom_{B}/Vcom_{G}/Vcom_{R} and the gray-scale voltages from the data lines 104B/104G/104R, rotations of the LC molecules in the first pixel 120B, the second pixel 120G, and the third pixel 120R are different. Accordingly, gamma curves respectively representing the transmittance-voltage characteristics of the first pixel 120B, the second pixel 120G and the third pixel 120R are respectively adjusted for solving its color shift problem at the large viewing angle. When the gray-scales from the first data line 104B, the second data line 104G, and the third data line 104R are the identical to each other, the first common voltage Vcom_{B}, the second common voltage Vcom_{G}, and the third common voltage Vcom_{R} that are different from each other are provided to adjust the gamma curves of the first pixel 120B, the second pixel 120G, and the third pixel 120R. Thus the blue, green, and red color shift problem respectively in the first pixel 120B, the second pixel 120G, and the third pixel 120R are all solved.

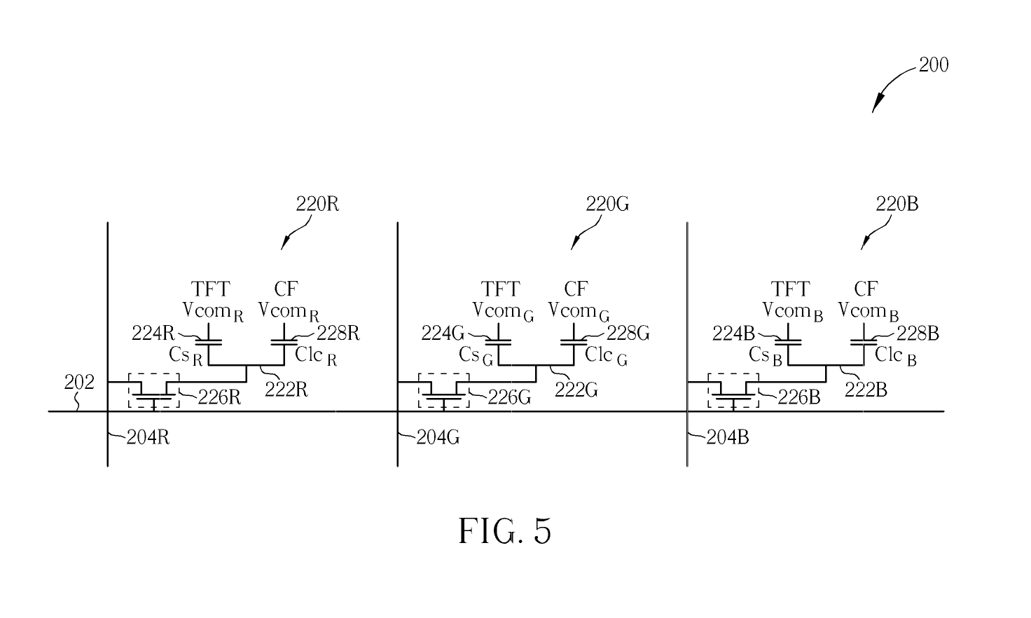

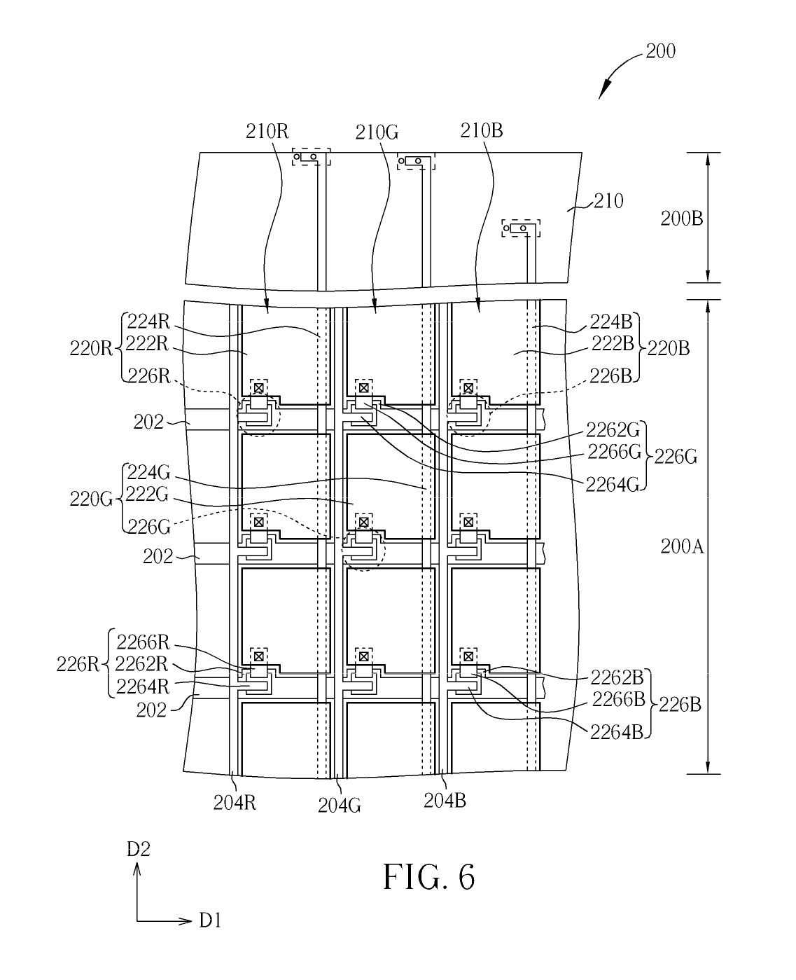

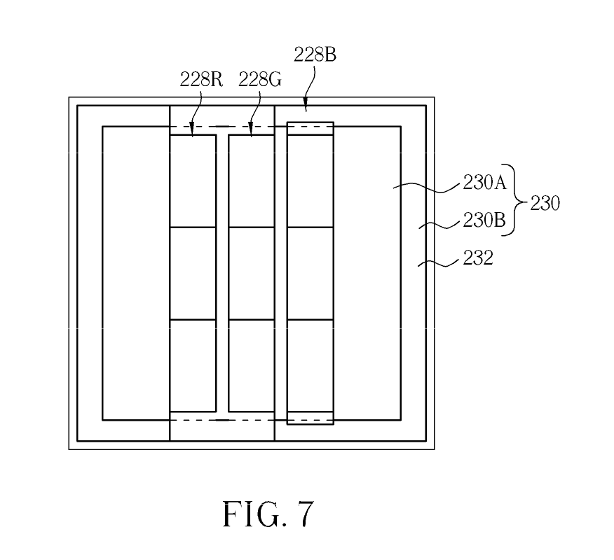

Please refer to FIGS. 5-7 wherein FIG. 5 is an equivalent circuit diagram of an LCD panel provided by a second preferred embodiment of the present invention, FIG. 6 is a drawing illustrating pixel arrangement of the LCD panel provided by the second preferred embodiment, and FIG. 7 is a drawing illustrating a color filter substrate of the LCD panel provided by the second preferred embodiment. As shown in FIG. 5 and FIG. 6, the second preferred embodiment provides a LCD panel 200 including a first substrate 210 (shown in FIG. 6) having a display region 200A and a peripheral circuit region 200B defined thereon. The LCD panel 200 includes at least a scan line 202 positioned along a first direction D1 on the first substrate 210. The LCD panel 200 further includes a first data line 204B, a second data line 204G and a third data line 204R positioned along a second direction D2 on the first substrate 210. The first direction D1 is perpendicular to the second direction D2. As shown in FIG. 5 and FIG. 6, the scan line 202 and the first data line 204B define a first pixel region 210B, the scan line 202 and the second data line 204G define a second pixel region 210G, and the scan line 202 and the third data line 204R define a third pixel region 210R.

The LCD panel 200 further includes a first pixel 220B formed in the first pixel region 210B, a second pixel 220G formed in the second pixel region 210G, and a third pixel 220R formed in the third pixel region 210R. In the preferred embodiment, the first pixel 220B is a blue pixel, the second pixel 220G is a green pixel, and the third pixel 220R is a red pixel. As shown in FIG. 6, the first pixel 220B includes a first pixel electrode 222B, a first storage electrode 224B, and a first TFT 226B positioned on the first substrate 210. The second pixel 220G includes a second pixel electrode 222G, a second storage electrode 224G and a second TFT 226G positioned on the first substrate 210. And the third pixel 220R includes a third pixel electrode 222R, a third storage electrode 224R and a third TFT 226R positioned on the first substrate 210. Since the spatial relationships of the first pixel 220B, the second pixel 220G, and the third pixel 220R are the same in both of the second preferred embodiment and the first preferred embodiment, those details are omitted for the sake of simplicity. As shown in FIG. 6, the scan line 202, the first data line 204B, the second data line 204G, and the third data line 204R all extend from the display region 200A of the first substrate 210 into the peripheral circuit region 200B. The scan line 202 is electrically connected to a scan line driving circuit while the first data line 204B, the second data line 204G and the third data line 204R are electrically connected to a data line driving circuit in the peripheral circuit region 200B. Since the details are well-known to those skilled in the art, those details are omitted hereinafter and FIGS. 5-7.

Please still refer to FIG. 5 and FIG. 6. The first storage electrode 224B has a first common voltage Vcom_{B}, the second storage electrode 224G has a second common voltage Vcom_{G}, and the third storage electrode 224R has a third common voltage Vcom_{R}. It is noteworthy in the preferred embodiment, the first common voltage Vcom_{B}is not equal to the second common voltage Vcom_{G}, but the second common voltage Vcom_{G} is equal to the third common voltage Vcom_{R}. Furthermore, the first pixel electrode 222B and the first storage electrode 224B form a first storage capacitor Cs_{B}, the second pixel electrode 222G and the second storage electrode 224G form a second storage capacitor Cs_{G}, and the third pixel electrode 222R and the third storage electrode 224R form a third storage capacitor Cs_{R}. As shown in FIG. 7, the first storage electrode 224B is arranged along the second direction D2 that means the first storage electrode 224B is formed parallel with the first data line 204B. In the same concept, the second storage electrode 224G is formed parallel with the second data line 204G and the third storage electrode 224R is formed parallel with the third data line 204R. It is noticeable that the first storage electrode 224B, the second storage electrode 224G and the third storage electrode 224R extend from the display region 200A of the first substrate 210 into the peripheral region 200B of the first substrate 210. Lengths of the second storage electrode 224G and the third storage electrode 224R, of which the common voltages Vcom_{R}/Vcom_{G} are the same, are identical with each other while a length of the first storage electrode 224B is different from that of the second storage electrode 224G and the third storage electrode 224R. As shown in FIG. 6, the length of the first storage electrode 224B is shorter than the lengths of the second storage electrode 224G and the third storage electrode 224R. Accordingly, terminals of the first storage electrode 224B in the peripheral circuit region 200B are formed lower than terminals of the second storage electrode 224G and of the third storage electrode 224R along the second direction D2.

Please still refer to FIG. 6. The first TFT 226B further includes a first gate 2262B electrically connected to the scan line 202, a first source 2264B electrically connected to the first data line 204B, and a first drain 2266B electrically connected to the first pixel electrode 222B. The second TFT 226G further includes a second gate 2262G electrically connected to the scan line 202, a second source 2264G electrically connected to the second data line 204G, and a second drain 2266G electrically connected to the second pixel electrode 222G. The third TFT 226R further includes a third gate 2262R electrically connected to the scan line 202, a third source 2264R electrically connected to the third data line 204R, and a third drain 2266R electrically connected to the third pixel electrode 222R. Since the operation of the TFTs 226B/226G/226R is well-known to those skilled in the art, the details are omitted herein in the interest of brevity.

Please refer to FIG. 7. According to the preferred embodiment, the LCD panel 200 further includes a second substrate 230. The second substrate 230 also includes a display region 230A and a peripheral circuit region 230B. The first pixel 220B further includes a first common electrode 228B, the second pixel 220G further includes a second common electrode 228G, and the third pixel 220R further includes a third common electrode 228R. All of the common electrodes 228B/228G/228R include transparent conductive materials and are formed on the second substrate 230. The first common electrode 228B is electrically connected to the first storage electrode 224B, and the first common electrode 228B and the first pixel electrode 222B form a first liquid crystal capacitor Clc_{B}. In the same concept, the second common electrode 228G is electrically connected to the second storage electrode 224G, and the second common electrode 228G and the second pixel electrode 222G form a second liquid crystal capacitor Clc_{G}. The third common electrode 228R is electrically connected to the third storage electrode 224R, and the third common electrode 228R and the third pixel electrode 222R form a third liquid crystal capacitor Clc_{R}.

It is noteworthy that the first common electrode 228B is formed corresponding to the first pixel region 210B, the second common electrode 228G is formed corresponding to the second pixel region 210G, and the third common electrode 228R is formed corresponding to the third pixel region 210R. Therefore the first common electrode 228B, the second common electrode 228G, and the third common electrode 228R are parallel with each other as shown FIG. 7. The first common electrode 228B, the second common electrode 228G, and the third common electrode 228R are arranged individually and respectively according to blue, green red without contacting. Furthermore, the first common electrode 228B, the second common electrode 228G, and the third common electrode 228R extend from the display region 230A into the peripheral circuit region 230B. More important, a length of the first common electrode 228B is corresponding to the length of the first storage electrode 224B, and lengths of the second common electrode 228G and the third common electrode 228R are corresponding to the lengths of the second storage electrode 224G and the third storage electrode 224R. Accordingly, the length of the first common electrode 228B is shorter than the lengths of the second common electrode 228G and the third common electrode 228R while the length of the second common electrode 228G and the length of the third common electrode 228R are the same. Therefore in the peripheral circuit region 230B, terminals of the first common electrode 228B are positioned lower than terminals of the second common electrode 228G and of the third common electrode 228R along the second direction D2. The two terminals of the first common electrode 228B are corresponding to the two terminals of the first storage electrode 224B, and the two terminals of the second common electrode 228G and of the third common electrode 228R are respectively corresponding to the two terminals of the second storage electrode 224G and of the third storage electrode 224R. By conductive material 232 such as conductive spacer in the sealant or Ag-sealant, the first common electrode 228B, the second common electrode 228G, and the third common electrode 228R are respectively electrically connected to the first storage electrode 224B, the second storage electrode 224G, and the third storage electrode 224R in the peripheral circuit region 230B.

Please refer to FIG. 5 again. According to the preferred embodiment, the first common electrode 228B electrically connected to the first storage electrode 224B has the first common voltage Vcom_{B}, the second common electrode 228G electrically connected to the second storage electrode 224G has the second common voltage Vcom_{G}, and the third common electrode 228R electrically connected to the third storage electrode 224R has the third common voltage Vcom_{R}. As mentioned above, the first common voltage Vcom_{B} is different from the second common voltage Vcom_{G} and the third common voltage Vcom_{R}, but the second common voltage Vcom_{G} and the third common voltage Vcom_{R} are identical.

It is well-known the blue pixel suffers color shift problem more serious than the red and green pixels do at the large viewing angle. Therefore the second preferred embodiment individually and independently controls the first common voltage Vcom_{B} for the first pixel 220B while the second common voltage Vcom_{G} of the second pixel 220G and the third common voltage Vcom_{R} of the third pixel 220R are controlled together. When the first TFT 226B, the second TFT 226G and the third 226B are turned on according to the control signal from the same scan line 202, and the gray-scale voltages are received from the first data line 204B, the second data line 204G and the third data line 204R, the first common voltage Vcom_{B} that is different from the second common voltage Vcom_{G} and the third common voltage Vcom_{R} are provided. By voltage differences between the first common voltage Vcom_{B}and the gray-scale voltage from the first data line 204B and between the second and third common voltages Vcom_{G}/Vcom_{R} and the gray-scale voltages from the data lines 204G/204R, rotations of the LC molecules in the first pixel 220B are adjusted independently while rotations of the LCD molecules in the second and third pixel 220G/220R are equally adjusted. Accordingly, the blue, green, and red color shift problem respectively in the first pixel 220B, the second pixel 220G, and the third pixel 220R, while the first pixel 220B suffers more serious color shift problem, are all solved.

According to the LCD panel provided by the present invention, the first common voltage, the second common voltage and the third common voltage are respectively provided to the first storage electrode, the second storage electrode and the third storage electrode, and first common voltage is not equal to at least one of the second common voltage and the third common voltage. Accordingly, even the first pixel, the second pixel and the third pixel obtain the same gray-scale voltages from the data lines, the gray scale of the first pixel is different from that of the second pixel and of the third pixel because the difference between the first common voltage and at least one of the second common voltage and the third common voltage. Consequently, color shift problem is solved even at large viewing angle. Furthermore, since the gamma curves are adjusted by providing different first common voltage, second common voltage, and third common voltage, the present invention is able to solve the color shift problem without complicating the system circuit and the manufacturing processes in the state-of-the-art, which divides a pixel region into two sub-regions according to different gamma curves.

Those skilled in the art will readily observe that numerous modifications and alterations of the device and method may be made while retaining the teachings of the invention.

What is claimed is:

1. A liquid crystal display (LCD) panel for solving color shift comprising:
a first substrate having a first pixel region, a second pixel region, and a third pixel region;
a first pixel formed in the first pixel region, the first pixel comprising:
a first pixel electrode, positioned on the first substrate; and
a first storage electrode positioned on the first substrate, the first storage electrode having a first common voltage, and the first pixel electrode and the first storage electrode form a first storage capacitor;
a second pixel formed in the second pixel region, the second pixel comprising:
a second pixel electrode positioned on the first substrate; and
a second storage electrode positioned on the first substrate, the second storage electrode having a second common voltage, and the second pixel electrode and the second storage electrode form a second storage capacitor; and
a third pixel formed in the third pixel region, the third pixel comprising:
a third pixel electrode positioned on the first substrate; and
a third storage electrode positioned on first substrate, the third storage electrode having a third common voltage, and the third pixel electrode and the third storage electrode form a third storage capacitor;
wherein the first common voltage is not equal to at least one of the second common voltage and the third common voltage.

2. The LCD panel for solving color shift according to claim 1, further comprising a scan line positioned on the first substrate and along a first direction and a first data line, a second data line and a third data line positioned on and along a second direction, wherein the scan line and the first data line define the first pixel region, the scan line and the second data line define the second pixel region, and the scan line and the third data line define the third pixel region.

3. The LCD panel for solving color shift according to claim 2, wherein the first pixel comprises a first thin film transistor (TFT), the second pixel comprises a second TFT, and the third pixel comprises a third TFT.

4. The LCD panel for solving color shift according to claim 3, wherein the first TFT further comprises:
a first gate electrically connected to the scan line;
a first source electrically connected to the first data line; and
a first drain electrically connected to the first pixel electrode.

5. The LCD panel for solving color shift according to claim 3, wherein the second TFT further comprises:
a second gate electrically connected to the scan line;
a second source electrically connected to the second data line; and
a second drain electrically connected to the second pixel electrode.

6. The LCD panel for solving color shift according to claim 3, wherein the third TFT further comprises:
a third gate electrically connected to the scan line;
a third source electrically connected to the third data line; and
a third drain electrically connected to the third pixel electrode.

7. The LCD panel for solving color shift according to claim 1, further comprising a second substrate, the first pixel having a first common electrode corresponding to the first pixel region formed on the second substrate, and the first common electrode is electrically connected to the first storage electrode and form a first liquid crystal capacitor with the first pixel electrode, the second pixel having a second common electrode corresponding to the second pixel region on the second substrate, the second common electrode is electrically connected to the second storage electrode and form a second liquid crystal capacitor with the second pixel electrode, and the third pixel having a third common electrode corresponding to the third pixel region formed on the second substrate, the third common electrode is electrically connected to the third storage electrode and form a third liquid crystal capacitor with the third pixel electrode.

8. The LCD panel for solving color shift according to claim 1, wherein the first common voltage is not equal to the second common voltage, the second common voltage is not equal to the third common voltage, and the third common voltage is not equal to the first common voltage.

9. The LCD panel for solving color shift according to claim 1, wherein the first pixel is a blue pixel, the second pixel is a green pixel and the third pixel is a red pixel.

10. The LCD panel for solving color shift according to claim 1, wherein the first common voltage is not equal to the second common voltage and the second common voltage is equal to the third common voltage.
